(19) United States
(12) Patent Application Publication
(10) Pub. No.: US 2010/0000787 A1
(43) Pub. Date: Jan. 7, 2010

(54) FLAME-RETARDANT RESIN COMPOSITION, AN INSULATED WIRE AND A WIRING HARNESS

(75) Inventors: Tatsuya Shimada, Yokkaichi-shi (JP); Tsuyoshi Nonaka, Yokkaichi-shi (JP); Masato Inoue, Yokkaichi-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., YOKKAICHI-SHI (JP); SUMITOMO WIRING SYSTEMS, LTD., YOKKAICHI-SHI (JP); SUMITOMO ELECTRIC INDUSTRIES, LTD., OSAKA-SHI (JP)

(21) Appl. No.: 12/312,822

(22) PCT Filed: Dec. 12, 2007
(86) PCT No.: PCT/JP2007/073907

§ 371 Date: Jun. 9, 2009

(30) Foreign Application Priority Data
Dec. 12, 2006 (JP) 2006-334055

(51) Int. Cl. H01B 7/00; C08K 3/22; H01B 7/295

(52) U.S. Cl. 174/72 A; 524/436; 174/110 SR

(57) ABSTRACT

A flame retardant resin composition which is reasonable in price and possesses superior cold resistance, wear resistance and hot-water resistance, an insulated wire and a wiring harness. The flame-retardant resin composition includes a propylene polymer including an ethylene unit within a range of 1 to 15 mass %, and magnesium hydroxide derived from a natural mineral. The content of the magnesium hydroxide is preferably within a range of 50 to 200 parts by mass with respect to 100 parts by mass of a polymer component in the composition. A styrene-type thermoplastic elastomer is preferably included in the composition. A Charpy impact value of the propylene polymer at a temperature of −20° C. is preferably 3 to 8 KJ/m². An insulated wire includes a conductor and the flame-retardant resin composition which covers the conductor, and a wiring harness includes the insulated wire.

### TECHNICAL FIELD

The present invention relates to a flame-retardant resin composition, an insulated wire and a wiring harness, and more specifically relates to a flame-retardant resin composition which is suitable for a covering material of an insulated wire used for an automobile and an electrical/electronic appliance, an insulated wire and a wiring harness.

### BACKGROUND ART

Conventionally, for a covering material of an insulated wire used in carrying out wiring of parts for an automobile and an electrical/electronic appliance, there is widespread use of a vinyl chloride resin composition to which a halogenous flame retardant is added.

However, there is a problem that the vinyl chloride resin composition includes halogen elements, so that it emits harmful halogenous gas into the atmosphere in case of car fire or at the time of combustion for disposing of an electrical/electronic appliance by incineration, causing environmental pollution.

From the view point of reducing loads on the global environment, an olefin resin such as polyethylene has been recently used for a covering material of an insulated wire. Because the olefin resin does not have flame retardancy by itself, a metallic hydrate such as magnesium hydroxide is added to the olefin resin as a flame retardant. For the magnesium hydroxide, magnesium hydroxide synthesized from sea water is commonly used, for example.

However, the olefin resin requires a large amount of magnesium hydroxide to be added thereto in order to secure sufficient flame retardancy. In addition, the magnesium hydroxide synthesized from sea water is expensive, so that there is a problem that a manufacturing cost increases.

In view of this, an attempt has been made to use magnesium hydroxide derived from a natural mineral which is reasonable in price as a flame retardant.

For example, Japanese Patent Application Unexamined Publication No. Hei7-161230 discloses a flame-retardant composition composed of a plastic or a rubber and a flame retardant prepared by using a pulverized natural mineral which is mainly composed of magnesium hydroxide and surface-treated with a fatty acid or other agents.

### DISCLOSURE OF THE INVENTION

### Problems to be Solved by the Invention

However, the magnesium hydroxide derived from a natural mineral is prepared by pulverizing a natural mineral, and therefore, particles thereof vary in diameter and shapes thereof are pointed, as different from the magnesium hydroxide synthesized from sea water. For this reason, the particles become prone to cohere with each other, resulting in degradations of cold resistance, wear resistance and hot-water resistance of materials.

An object of the present invention is to provide a flame-retardant resin composition which is reasonable in price and possesses superior cold resistance, wear resistance and hot-water resistance, an insulated wire and a wiring harness.

### Means to Solve the Problem

A flame-retardant resin composition according to a preferred embodiment of the present invention includes a propylene polymer including an ethylene unit within a range of 1 to 15 mass % and magnesium hydroxide derived from a natural mineral.

The flame-retardant resin composition preferably includes 50 to 200 parts by mass of the magnesium hydroxide with respect to 100 parts by mass of a polymer component in the composition.

The flame-retardant resin composition may preferably include a styrene type thermoplastic elastomer.

A mass ratio of the styrene type thermoplastic elastomer to the propylene polymer is preferably within a range of 30/70 to 5/95.

A Charpy impact value of the propylene polymer at a temperature of −20° C. is preferably 3 to 8 KJ/m².

An insulated wire according to a preferred embodiment of the present invention includes a conductor and the flame-retardant resin composition which covers the conductor.

A wiring harness according to a preferred embodiment of the present invention includes the insulated wire described above.

### EFFECTS OF THE INVENTION

The flame-retardant resin composition according to the preferred embodiment of the present invention includes the polymer component including the ethylene unit within the specific range, the propylene unit, and the magnesium hydroxide as a flame retardant. For this reason, the flame-retardant resin composition possesses superior cold resistance, wear resistance and hot-water resistance. Further, the magnesium hydroxide included in the composition is derived from a natural mineral, so that it is possible to prepare a flame-retardant resin composition which is reasonable in price than that using a synthesized magnesium hydroxide.

The magnesium hydroxide derived from a natural mineral is prepared by pulverizing a mineral, so that large surface asperities are produced, and therefore, tendencies to degrade hot-water resistance, cold resistance and wear resistance of the materials are shown. However, the preferred embodiment of the present invention makes it possible to minimize degradations of these properties. The reason thereof may be that the particles of the magnesium hydroxide added to the polymer component have sufficient affinity for the ethylene unit included in the propylene polymer within the specific range, so that they are well dispersed in the polymer component when mixed, whereby cohesion is less prone to occur.

If the flame-retardant resin composition includes 50 to 200 parts by mass of the magnesium hydroxide with respect to 100 parts by mass of the polymer component in the composition, sufficient flame retardancy is secured.

Further, if the styrene type thermoplastic elastomer is included, superior flexibility is achieved.

If amass ratio of the styrene type thermoplastic elastomer to the propylene polymer is within a range of 30/70 to 5/95, the effects described above are improved.

Further, if the Charpy impact value of the propylene polymer at a temperature of −20° C. is 3 to 8 KJ/m², excellent cold resistance and flexibility are shown.

Because the insulated wire according to the preferred embodiment of the present invention and the wiring harness including the insulated wire have a conductor and the flame-retardant resin composition described above which covers the conductor, the insulated covering material is less prone to degradation, and thus high reliability can be ensured for a long period of time.

### BEST MODE FOR CARRYING OUT THE INVENTION

A detailed description of preferred embodiments of the present invention will now be provided.

A flame-retardant resin composition according to the preferred embodiment of the present invention includes a propylene polymer, and magnesium hydroxide as a flame retardant.

The propylene polymer includes an ethylene unit within a range of 1 to 15 mass %, and more preferably within a range of 3 to 12 mass %. It is added that the ethylene unit refers to a unit which is formed from an ethylene monomer when the ethylene monomer is homopolymerized or copolymerized.

For forming the propylene polymer which includes the ethylene unit, it is preferable that the ethylene unit is included in a molecular structure of the propylene polymer. For the propylene polymer of this kind, a copolymer consisting of ethylene and propylene, a copolymer consisting of ethylene, propylene and other monomer are preferably used. For the other monomer, 1-butene is preferably used. The other monomer may be included by one sort alone, or more than one sort in combination.

Examples of the copolymer consisting of the ethylene and the propylene include a block copolymer in which the ethylene and the propylene are copolymerized in the form of blocks, and a random copolymer of the ethylene and the propylene copolymerized at random. Similarly, examples of the copolymer consisting of the ethylene, the propylene and the other monomer include a block copolymer of them and a random copolymer of them. A content ratio of the ethylene unit is expressed by the content of the ethylene unit in these copolymers.

For forming the propylene polymer which includes the ethylene unit, a propylene homopolymer and an ethylene polymer may be mixed with each other. The ethylene polymer may be a homopolymer of ethylene or a copolymer of ethylene and other monomer. For the other monomer, 1-pentene is preferably used. The other monomer may be included by one sort alone, or more than one sort in combination. For the ethylene polymer, ethylene rubber and ethylene-propylene rubber are preferably used, for example. In this case, the content ratio of the ethylene unit is expressed by the content of the ethylene unit in the mixture.

The content of the ethylene unit in the propylene polymer is measured using NMR, for example. The content ratio of the ethylene unit is calculated based on the measured content. In the case of NMR, for example, the content of the ethylene unit is found by measuring a peak area of the ethylene unit in the propylene copolymer.

It is preferable that the propylene polymer has a melt flow rate (MFR) within a range of 0.1 to 5 g/10 min, and more preferably within a range of 0.1 to 3 g/10 min. If the MFR is less than 0.1 g/10 min, a tendency to degrade fluidity of the resin composition is shown, while if the MFR is more than 5 g/10 min, a tendency to degrade mechanical properties is shown. It is added that the melt flow rate (MFR) is measured in accordance with JIS K6758 (at a temperature of 230° C., and a load of 2.16 Kg).

Further, it is preferable that the propylene polymer has a Charpy impact value of 3 to 8 KJ/m² at a temperature of −20° C., and more preferably 3 to 6.5 KJ/m². If the Charpy impact value is less than 3 KJ/m², a tendency to degrade cold resistance is shown, while if the Charpy impact value is more than 8 KJ/m², a tendency to degrade flexibility of the insulated wire is shown. It is added that the Charpy impact value is measured in accordance with ISO179.

The polymer component in the composition may further include a thermoplastic elastomer. For the thermoplastic elastomer, a styrene type thermoplastic elastomer and 1,2-polybutadiene are preferably used.

For a component used for copolymerizing with a styrene in the styrene type thermoplastic elastomer, ethylene, propylene, butadiene and isoprene are preferably used. They may be used by one sort alone, or more than one sort in combination.

More specifically, a styrene-butadiene block copolymer, and a styrene-ethylene-styrene copolymer (SES) and a styrene-ethylene-butylene-styrene copolymer (SEBS) which are hydrogenated or partially-hydrogenated derivatives of the styrene-butadiene block copolymer; a styrene-isoprene block copolymer, and a styrene-ethylene-propylene copolymer (SEP) and a styrene-ethylene-propylene-styrene copolymer (SEPS) which are hydrogenated or partially-hydrogenated derivatives of the styrene-isoprene block copolymer; and a styrene-ethylene-ethylene-propylene-styrene copolymer (SEEPS) are preferably used.

When defining the styrene as a hard segment and the polymer arranged between the styrene as a soft segment, a ratio of the hard segment to the soft segment is preferably within a range of 10/90 to 40/60 in terms of the mass ratio.

The styrene type thermoplastic elastomer may be modified by acid. For the acid, a maleic acid, and a maleic acid anhydride, a maleic acid monoester and a maleic acid diester which are derivatives of the maleic acid; a fumaric acid, and a fumaric acid anhydride, a fumaric acid monoester, a fumaric acid diester which are derivatives of the fumaric acid are preferably used. They may be used by one sort alone, or more than one sort in combination.

To apply acid to the styrene type thermoplastic elastomer, a method such as a grafting method and a direct (copolymerization) method may be used. The amount of acid modification is preferably within a range of 0.1 to 10 mass % with respect to the styrene type thermoplastic elastomer, and more preferably within a range of 0.2 to 5 mass %. If the amount of acid modification is less than 0.1 mass %, a tendency to degrade wear resistance is shown, while if the amount of acid modification is more than 10 mass %, a tendency to degrade a molding property is shown.

A mass ratio of the styrene type thermoplastic elastomer to the propylene polymer is preferably within a range of 30/70 to 5/95. If so, excellent flexibility is achieved.

The polymer component in the composition may further include a rubber such as a butadiene rubber and an isoprene rubber. These rubbers may be modified by acid. For example, a modified butadiene rubber having core-shell structure and a modified isoprene rubber having core-shell structure or other rubber are preferably used.

The magnesium hydroxide as the flame retardant is preferably derived from a natural mineral. The magnesium hydroxide is derived from so-called natural brucite and is manufactured by wet-pulverizing or dry-pulverizing the natural brucite which is mainly composed of the magnesium hydroxide. The magnesium hydroxide is prepared by pulverizing the natural mineral, and thus the manufacturing cost is lower than that using a synthesized magnesium hydroxide.

It is preferable that the content of the magnesium hydroxide is within a range of 50 to 200 parts by mass with respect to 100 parts by mass of the polymer component in the composition, and more preferably within a range of 50 to 100 parts by mass. If the content of the magnesium hydroxide is less than 50 parts by mass, a tendency to degrade flame retardancy is shown, while if the content of the magnesium hydroxide is more than 200 parts by mass, difficulties in obtaining sufficient mechanical properties are increased.

The magnesium hydroxide is made into particles by a pulverizing process. It is preferable that the particle size is within a range of 0.5 to 20 μm, more preferably within a range of 0.5 to 10 μm, and yet more preferably within a range of 0.5 to 5 μm. If the particle size is less than 0.5 μm, a tendency to easily bring about secondary cohesion is shown, while if the particle size is more than 20 μm, a tendency to degrade an appearance of the wire is shown.

The magnesium hydroxide prepared by the pulverizing process has large surface asperities. For the reason, tendencies to degrade hot-water resistance, cold resistance and wear resistance of the materials are shown if simply highly filling the magnesium hydroxide into the composition. However, the flame-retardant resin composition according to the preferred embodiment of the present invention includes the ethylene unit within the specific range, so that degradations of the properties are prevented. The reason may be that the particles of the magnesium hydroxide added to the polymer component have sufficient affinity for the ethylene unit included in the propylene polymer within the specific range, so that they are well dispersed in the polymer component when mixed and the cohesion is less prone to occur.

Further, the magnesium hydroxide with large surface asperities shows a tendency to degrade adherence to the resin. For the reason, the magnesium hydroxide may be subjected to a surface treatment. For a treatment agent, a fatty acid, fatty acid salt, a fatty acid ester, a silane coupling agent and a titanate coupling agent are preferably used. They may be used by one sort alone, or more than one sort in combination.

It is preferable that the content of the treatment agent is within a range of 0.1 to 10 parts by mass with respect to 100 parts by mass of the magnesium hydroxide, and more preferably within a range of 0.5 to 3 parts by mass. If the content of the treatment agent is less than 0.1 parts by mass, a tendency to easily degrade an improvement of a characteristic of the wire is shown, while if the treatment agent is more than 10 parts by mass, excess of the thus-added treatment agent tends to remain as impurities, so that a tendency to degrade a physical property of the wire is shown.

When using a surface-treated magnesium hydroxide, a previously surface-treated magnesium hydroxide may be blended into the composition, or an untreated magnesium hydroxide may be blended with the treatment agent into the composition for the surface treatment of the magnesium hydroxide, which is not particularly limited.

The flame-retardant resin composition according to the preferred embodiment of the present invention, if needed, may include other additives provided that the properties of the flame-retardant resin composition are not impaired. The additives are not particularly limited, and a filler commonly used for a wire covering material, a pigment, an oxidation inhibitor, and an age inhibitor may be used, for example.

A method for manufacturing the flame-retardant resin composition according to the preferred embodiment of the present invention is not particularly limited, and a known method may be used. For example, the composition may be obtained by blending the polymer component including the propylene copolymer and the magnesium hydroxide, and the above-described arbitrary polymer component and other additives, as appropriate, then dry-blending them with the use of a regular tumbler or other devices, or melting and kneading them to disperse uniformly using a regular kneader such as a Banbury mixer, a pressure kneader, a kneading extruder, a twin-screw extruder and a roll.

Next, the insulated wire and a wiring harness according to the preferred embodiments of the present invention will be described.

The insulated wire according to the preferred embodiment of the present invention includes an insulated covering material prepared by using the flame-retardant resin composition described above. In the insulated wire, the insulated covering material may directly cover a conductor, or other intermediate material such as a shielded conductor or other insulator may be interposed there between.

The characteristics of the conductor such as the size and the material are not particularly limited and may be determined appropriately as usage. The thickness of the insulated covering material is not specifically limited, and may be determined considering factors such as the size of the conductor.

The insulated wire described above may be prepared by extrusion-covering the conductor using a commonly-used extrusion molding machine with the flame-retardant resin composition according to the preferred embodiment of the present invention described above which is kneaded using a commonly-used kneader such as a Banbury mixer, a pressure kneader and a roll.

The wiring harness according to the preferred embodiment of the present invention includes the insulated wires described above. The wiring harness may be configured as a wire bundle composed of the insulated wires described above only, or it may be configured as a wire bundle including an insulated wire covered with other resin composition such as a vinyl chloride insulated wire and other insulated wire which does not include a halogen element. The wire bundle is preferably covered with a wiring-harness protective material for example. The number of the wires is not particularly limited and may be arbitrarily determined.

The wiring-harness protective material covers the wire bundle, in which a plurality of insulated wires are bundled, to protect the wire bundle from the external environment for example. Although the base material of the wiring-harness protective material is not particularly limited, a polyolefin resin composition such as polyethylene and polypropylene is preferably used. It is preferable that a flame retardant is appropriately added to the resin composition.

As the wiring-harness protective material, a tape-shaped base material at least one side of which an adhesive is applied on, or one having a base material which is tube-shaped or sheet-shaped for example may be selected according to the intended use.

### Example

A description of the preferred embodiments of the present invention will now be given specifically with reference to Examples; however, the present invention is not limited hereto.

Test Material, Manufacturer, and Other Information

Test materials used in Examples are given along with manufacturers, trade names, values of physical properties, and other information. It is added that some of the test materials used in Examples are experimental materials prepared in a laboratory.

(A) Polypropylene Polymer

(a1) Ethylene-propylene copolymer (experimental) [ethylene-unit content ratio: 5%, Charpy impact value=5.1 KJ/m²];
(a2) Ethylene-propylene copolymer (experimental) [ethylene-unit content ratio: 8%, Charpy impact value=6.4 KJ/m²];
(a3) Polypropylene [manuf.: Prime Polymer Co., Ltd., trade name: “E-105GM”, ethylene-unit content ratio: 0%];
(a4) Ethylene-propylene copolymer (experimental) [ethylene-unit content ratio: 17%, Charpy impact value=8.3 KJ/m²]

(B) Styrene Type Thermoplastic Elastomer

(b1) Styrene-ethylene-ethylene-propylene-styrene copolymer (SEEPS) [manuf.: Kuraray Co., Ltd., tradename: “SEPTON4044”] 2% acid modified;
(b2) Styrene-ethylene-ethylene-propylene-styrene copolymer (SEEPS) [manuf.: Kuraray Co., Ltd., trade name: “SEPTON4055”];
(b3) Styrene-ethylene-propylene copolymer (SEP) [manuf.: Kuraray Co., Ltd., trade name: “SEPTON1020”];
(b4) Styrene-ethylene-butylene-styrene copolymer (SEBS) [manuf.: Kraton Polymers JAPAN Ltd., trade name: “KRATON FG1901X”]
(b5) Styrene-ethylene-butylene-styrene copolymer (SEBS) [manuf.: Asahi Kasei Chemicals Corporation, trade name: “Tuftec H1041”] 2% acid modified;
(b6) Styrene-ethylene-propylene-styrene copolymer (SEPS) [manuf.: Kuraray Co., Ltd., trade name: “SEPTON2002”] 2% acid modified

It is added that (b1), (b5) and (b6) are obtained by acid-modifying purchased products in the laboratory. These acid-modified products are grafted with a maleic anhydride.

(C) Flame Retardant

(c1) Magnesium hydroxide [manuf.: FIMATEC LTD., trade name: “Junmag”]

It is added that the magnesium hydroxide is a pulverized natural mineral which is surface-treated with 1 part by mass of a silane coupling agent with respect to 100 parts by mass of the magnesium hydroxide.

(D) Age Inhibitor

(d1) Hindered phenolic antioxidant [manuf.: Ciba Specialty Chemicals Inc., trade name: “Irganox1010”]

Preparation of Flame-Retardant Composition and Insulated Wire

Firstly, ingredients shown in the below-described table were kneaded at a mixing temperature of 250° C. with the use of a twin-screw extruder and pelletized using a pelletizing machine. Accordingly, flame-retardant resin compositions according to Examples and flame-retardant resin compositions according to Comparative Examples were obtained. Then, by extrusion-covering conductors (cross sectional area: 0.5 mm²), which are soft-copper strands prepared by bunching seven soft copper wires, with the obtained compositions to have a thickness of 0.25 mm using a 50 mm extruder, insulated wires according to Examples and Comparative Examples were prepared.

Test Method

The respective insulated wires prepared as above were subjected to a flame-retardancy test, a cold-resistance test, a wear-resistance test, a hot-water resistance test and a tensile-elongation test. Hereinafter, descriptions of procedures of the respective tests and respective assessment criteria will be provided.

Flame-Retardancy Test

The flame-retardancy test was performed in accordance with JASO D611-94. To be more specific, the insulated wires were cut into test specimens 300 mm long. Then, each of the test specimens was placed in an iron test box to be held horizontal, and the tip of a reducing flame by a Bunsen burner having a caliber of 10 mm was placed beneath the center of the test specimen within 30 seconds until it burned, and then, after the flame was calmly removed, after flame time of the test specimen was measured. The test specimen whose after flame time was within 15 seconds was regarded as passed, and the one whose after flame time was over 15 seconds was regarded as failed.

Cold-Resistance Test

The cold-resistance test was performed in accordance with JIS C3005, and the insulated wire in which all of the test specimens were not broken at a temperature of −20° C. or less was regarded as passed.

Wear-Resistance Test

The wear-resistance test was performed in accordance with ISO6722, and the specimen whose smallest reciprocation number in four-time measurements was 300 or more was regarded as passed.

Hot-Water Resistance Test

The hot-water resistance test was performed in accordance with ISO6722, and the insulated wire whose conductor did not expose after 35 days had passed and an insulation breakdown did not occur in a voltage resistance test was regarded as passed.

Tensile-Elongation Test

The tensile-elongation test was performed in accordance with JASO D611, and the insulated wire whose elongation was more than or equal to 300% at a tensile speed of 200 mm/min was regarded as passed.

Table 1 shows ingredient constitution and assessment results of the compositions. It is added that the row of the content ratio of the ethylene unit shown in Table 1 provides the content of the ethylene unit in the polypropylene copolymer in mass %.

TABLE 1

| | | Example | | | | | | | |
|---|---|---|---|---|---|---|---|---|---|
| | | 1 | 2 | 3 | 4 | 5 | 6 | 7 | 8 |
| Resin | (a1) Ethylene-propylene copolymer | 90 | 90 | 90 | | | | | |
| Composition | (a2) Ethylene-propylene copolymer | | | | 90 | 90 | 90 | 90 | 90 |
| | (a3) Polypropylene | | | | | | | | |
| | (a4) Ethylene-propylene copolymer | | | | | | | | |
| | (b1) SEEPS (2% acid modified) | 10 | | | 10 | | | | |
| | (b2) SEEPS | | | | | | | | |
| | (b3) SEP | | 10 | | | 10 | | | |
| | (b4) SEBS | | | | | | | | |
| | (b5) SEBS (2% acid modified) | | | 10 | | | 10 | 10 | 10 |
| | (b6) SEPS (2% acid modified) | | | | | | | | |
| | (c1) Magnesium hydroxide | 80 | 80 | 80 | 80 | 80 | 80 | 50 | 200 |
| | (d1) Hindered phenolic antioxidant | 1 | 1 | 1 | 1 | 1 | 1 | 1 | 1 |
| | Content ratio of Ethylene unit (mass %) | 5 | 5 | 5 | 8 | 8 | 8 | 8 | 8 |
| Assessment | Flame retardancy | passed | passed | passed | passed | passed | passed | passed | passed |
| | Cold resistance | passed | passed | passed | passed | passed | passed | passed | passed |
| | Wear resistance | passed | passed | passed | passed | passed | passed | passed | passed |
| | Hot-water resistance | passed | passed | passed | passed | passed | passed | passed | passed |
| | Tensile elongation | passed | passed | passed | passed | passed | passed | passed | passed |

| | | Example | | Comparative Example | | | | |
|---|---|---|---|---|---|---|---|---|
| | | 9 | 10 | 1 | 2 | 3 | 4 | 5 |
| Resin | (a1) Ethylene-propylene copolymer | 80 | 70 | | | | | |
| Composition | (a2) Ethylene-propylene copolymer | | | | | | | |
| | (a3) Polypropylene | | | 90 | | | | |
| | (a4) Ethylene-propylene copolymer | | | | 90 | 90 | 90 | 90 |
| | (b1) SEEPS (2% acid modified) | 20 | 30 | | | | | |
| | (b2) SEEPS | | | | | | 10 | |
| | (b3) SEP | | | | | | | |
| | (b4) SEBS | | | | | 10 | | |
| | (b5) SEBS (2% acid modified) | | | | | | | 10 |
| | (b6) SEPS (2% acid modified) | | | 10 | 10 | | | |
| | (c1) Magnesium hydroxide | 80 | 80 | 80 | 80 | 80 | 80 | 40 |
| | (d1) Hindered phenolic antioxidant | 1 | 1 | 1 | 1 | 1 | 1 | 1 |
| | Content ratio of Ethylene unit (mass %) | 5 | 5 | 0 | 17 | 17 | 17 | 17 |
| Assessment | Flame retardancy | passed | passed | passed | passed | passed | passed | failed |
| | Cold resistance | passed | passed | failed | passed | passed | passed | passed |
| | Wear resistance | passed | passed | passed | failed | failed | failed | failed |
| | Hot-water resistance | passed | passed | passed | passed | passed | failed | passed |
| | Tensile elongation | passed | passed | failed | passed | passed | passed | passed |

It is found that the insulated wires according to Comparative Examples are inferior in any of the assessment items of flame retardancy, cold resistance, wear resistance, hot-water resistance, and tensile elongation.

To be more specific, the insulated wire according to Comparative Example 1 uses the polypropylene polymer which does not include the ethylene unit, and therefore, the insulated wire according to Comparative Example 1 is insufficient in cold resistance. The insulated wire according to Comparative Example 1 is also insufficient in tensile elongation. The insulated wires according to Comparative Examples 2 to 5 use the polypropylene polymer whose content ratios of the ethylene unit are more than 15 mass %, and therefore, the insulated wires according to Comparative Examples 2 to 5 are insufficient in wear resistance. The insulated wire according to Comparative Example 4 is insufficient in not only wear resistance but also hot-water resistance. In addition, the insulated wire according to Comparative Example 5 is insufficient in not only wear resistance but also flame retardancy.

Contrarily, the insulated wires according to Examples are found superior in all of flame retardancy, cold resistance, wear resistance, hot-water resistance and tensile elongation.

While preferred embodiments of the present invention have been described above, it is to be understood that variations and modifications will be apparent to those skilled in the art without departing the scope and spirit of the present invention.

### INDUSTRIAL APPLICABILITY

The flame-retardant resin composition according to the preferred embodiment of the present invention is suitable for a covering material of an insulated wire used for an automobile and an electrical/electronic appliance.

1. A flame-retardant resin composition, comprising:
a propylene polymer including an ethylene unit within a range of 1 to 15 mass %; and
magnesium hydroxide derived from a natural mineral.

2. The flame-retardant resin composition according to claim 1, wherein the content of the magnesium hydroxide is 50 to 200 parts by mass with respect to 100 parts by mass of a polymer component in the composition.

3. The flame-retardant resin composition according to claim 1 further comprising a styrene type thermoplastic elastomer.

4. The flame-retardant resin composition according to claim 3, wherein a mass ratio of the styrene type thermoplastic elastomer to the propylene polymer is within a range of 30/70 to 5/95.

5. The flame-retardant resin composition according to claim 1, wherein a Charpy impact value of the propylene polymer at a temperature of −20° C. is 3 to 8 KJ/m².

6. An insulated wire comprising:
a conductor; and
the flame-retardant resin composition according to claim 1 which covers the conductor.

7. A wiring harness comprising the insulated wire according to claim 6.
